(19) United States
(12) Patent Application Publication
(10) Pub. No.: US 2020/0408507 A1
(43) Pub. Date: Dec. 31, 2020

(54) SYSTEM FOR AUTOMATED SURVEYING OF MOTOR VEHICLES

(71) Applicant: TKR Spezialwerkzeuge GmbH, Gevelsberg (DE)

(72) Inventor: Torsten Kreischer, Wetter (DE)

(21) Appl. No.: 16/912,768

(22) Filed: Jun. 26, 2020

(30) Foreign Application Priority Data
Jun. 27, 2019 (DE) 10 2019 117 428.7

(51) Int. Cl. G01B 11/00; B60W 50/06; G07C 5/08; G07C 5/00; G01B 11/27; G01B 11/24

(52) U.S. Cl. CPC G01B 11/005; B60W 50/06; G01B 11/24; G07C 5/008; G01B 11/272; G07C 5/0808

(57) ABSTRACT

A system for automated surveying of motor vehicles, in particular passenger cars. To provide a system for automated surveying of motor vehicles, in particular passenger cars, which allows for precise surveying of the motor vehicle bodywork and/or the chassis of the motor vehicle, the system has a measuring unit including a scanning unit designed for contactless and/or tactile 3D detection of the geometry of the motor vehicle bodywork and/or surveying of the chassis of the motor vehicle. Furthermore, the measuring unit includes a travel unit for moving and orienting the measuring unit, and a central control unit for automatically controlling the measuring unit and orienting the scanning unit relative to the motor vehicle.

The invention relates to a system for automated surveying of motor vehicles, in particular passenger cars, with a measuring unit.

Modern motor vehicles, in particular passenger cars, comprise a plurality of vehicle sensors and/or cameras that are used in the operation of different assistance systems that assist the driver in particular driving situations. Currently known functionalities of the driver assistance systems include, for example, a lane departure warning system, adaptive cruise control, a lane change assistant and an emergency brake assistant. In order to detect the situation in the surroundings, the assistance systems use different sensors, such as ultrasound sensors or radar, lidar and cameras, which send the corresponding assistance systems the data required for the functioning thereof.

In addition to a precise orientation of the sensors and cameras, the precise positioning thereof in relation to the vehicle bodywork is also essential for flawless functioning of the assistance systems. Deviations in the positioning, which may for example occur as a result of repair work to the vehicle bodywork equipped with integrated sensors and cameras after an accident, impair the functioning of the assistance systems and may under unfavorable circumstances result in said assistance systems not functioning correctly. Precise restoration of the vehicle bodywork in the original dimensions thereof is therefore of vital importance for the functioning of the assistance systems. Another requirement for the functioning of some assistance systems, such as a lane departure warning system, is a correctly oriented chassis, the wheel position of which is monitored and, if necessary, altered by means of the assistance systems.

At present, repair work is merely monitored optically by the workshop staff, however deviations that are relevant to the decision are not possible to identify.

Proceeding from this, the object of the invention is to provide a system for automated surveying of motor vehicles, in particular passenger cars, which allows for precise surveying of the motor vehicle bodywork and/or the chassis of the motor vehicle.

The object is achieved according to the invention by a system for automated surveying according to claim 1. Advantageous further embodiments of the invention are specified in the dependent claims.

An essential element of the system according to the invention for automated surveying of motor vehicles is a measuring unit comprising
a scanning unit,
   which is designed for contactless and/or tactile 3D detection of the geometry of the motor vehicle bodywork and/or
   for surveying the chassis of the motor vehicle.

The scanning unit is connected to a travel unit, by means of which the measuring unit can be moved and oriented relative to the motor vehicle to be surveyed. A central control unit is used for automatic, automated control of the measuring unit and orientation of the scanning unit relative to the motor vehicle.

By moving the measuring unit relative to the motor vehicle in an automated manner, said measuring unit can be moved around the motor vehicle such that complete 3D detection of the vehicle bodywork takes place. Furthermore, additionally or alternatively, the entire chassis of the motor vehicle, in particular the lane or wheel position, can be surveyed. The measuring unit is moved by means of the central control unit of the measuring unit, which moves same in a predefined manner, for example depending on the type of vehicle.

Complete detection of the vehicle bodywork and/or the chassis of the motor vehicle makes it possible to compare the determined dimensions with the predefined vehicle-specific dimensions. Deviations outside a tolerance range can in this way be easily identified, such that such motor vehicles of which the motor vehicle bodywork or chassis does not meet the necessary requirements for proper operation of the driver assistance systems are prevented from being operated again.

The actual data recorded by means of the measuring unit can be compared against the target data directly in the control unit of the measuring unit. Alternatively, it is also possible to transmit the measurement data to a separate evaluation unit, in which the measurement data is compared with the motor vehicle-specific data stored in a database.

In order to transmit the specific motor vehicle data and/or the measurement data transmitted by the scanning unit, according to an advantageous further embodiment of the invention it is provided that the control unit is connected to a communication unit for transmitting the motor vehicle data and/or measurement data. The data may be transmitted wirelessly, e.g. via a Bluetooth or WLAN connection, the specific motor vehicle data then being called up via a central database and/or the measurement data being sent to an evaluation unit for evaluation. Furthermore, it is also possible to retrieve vehicle data directly at the vehicle via an OBD interface, for example, the communication unit being equipped with corresponding plug connections for this purpose.

In particular a direct communication with the vehicle to be surveyed, either wireless or wired, ensures in a particularly reliable manner that the data required for the measurement process are provided in the correct manner. Furthermore, it is also possible to retrieve target data potentially stored in the vehicle, such that said data can be directly compared against the measurement data. Alternatively, the target data may also be called up via a central database.

The geometry of the motor vehicle bodywork and/or the chassis may in principle be detected in any desired manner. It is possible, for example, to equip the scanning unit with tactile sensors, which are moved over the surface of the vehicle bodywork in order to gather the required object data. According to an advantageous embodiment of the invention, it is, however, provided that the scanning unit is designed to optically detect the geometry of the motor vehicle bodywork and/or survey the chassis, in particular comprises a laser scanner.

The use of an optical detection system, in particular a laser scanner, makes it possible to reliably detect the entire surface of the motor vehicle bodywork without touching same. During laser scanning, a suitable laser scanner sweeps over the surface of the vehicle bodywork or required reference points on the chassis in rows or a grid-like pattern using a laser beam in order to survey same. The use of a laser scanner allows for particularly precise generation of a 3D image of the motor vehicle bodywork and thus reliable determination of intolerable deviations after bodywork repairs.

In addition to precise positioning of the sensors and cameras of the vehicle and a properly oriented chassis, precise orientation of the sensors and cameras with respect to the axis of travel is also required for flawless functioning of the driver assistance systems. Therefore, after the sensors and/or cameras have needed to be replaced, for example within the scope of accident repair work, the orientation of the cameras and/or sensors has to be checked and, if necessary, adjusted in order to ensure the functioning of the assistance systems. For this according to an advantageous further embodiment of the invention it is provided that the measuring unit comprises an orientation element for orienting vehicle sensors and/or cameras on the vehicle.

The orientation elements may for example be a calibration panel, by means of which the orientation of the vehicle sensor and/or camera relative to the axis of travel can be checked, such that any required adjustment work can be carried out. By means of the travel unit, the measuring unit can be brought into the position required for the relevant orientation in an automated manner, it being possible to arrange the orientation element in a precise position for the checking.

The further embodiment according to the invention of the measuring unit having an orientation element therefore makes it possible to check the orientation of the vehicle sensors and, if necessary, make adjustments in a particularly simple and convenient manner. The orientation elements are positioned relative to the vehicle sensor and/or camera to be oriented by means of the travel unit, which makes it possible to freely position the orientation element in space relative to the vehicle. The travel unit may for example be a chassis having an electromotive drive connected to rollers that makes it possible to freely position the measuring unit in a simple manner in space, in particular in the workshop relative to the vehicle. The measuring unit is positioned and the orientation element is oriented by means of the central control unit.

The orientation of the orientation element may therefore be achieved solely by means of the travel unit, said travel unit offering the possibility of rotating the orientation element in addition to moving the measuring unit in space, as a result of which precise positioning can take place. According to a particularly advantageous embodiment of the invention, however, the orientation element is adjustably arranged on the measuring unit, for example by means of an actuator connected to the control unit. The actuator may be any desired adjustment mechanism via which the orientation element, for example a calibration panel, is connected to the measuring unit. Therefore, if necessary, particularly precise orientation of the orientation element can take place by means of the actuator after positioning of the measuring unit by means of the travel unit.

The motor vehicle may for example be surveyed by means of the measuring unit in such a way that the motor vehicle to be surveyed is positioned at a predefined measuring point around which the measuring unit then travels in a specified manner. According to an advantageous development of the invention, however, the measuring unit comprises a position detection unit connected to the travel unit for determining the position of the scanning unit and/or orientation element relative to the motor vehicle and/or the vehicle sensors and/or cameras. The position detection unit, which for example comprises a lidar system, acceleration sensors, magnetic field sensors, inclination sensors and/or 3D cameras, makes it possible to detect the vehicle such that the motor vehicle can be surveyed precisely even without precise positioning of the motor vehicle at the measuring point and without position sensors on the motor vehicle. Furthermore, the position detection unit makes possible precise determination of the position of the orientation element relative to the vehicle sensors and/or cameras. The position detection unit makes it possible to move the measuring unit freely relative to the vehicle within a specified range, it not being necessary to position the vehicle precisely in a predetermined measuring point for this purpose. At the same time, precise orientation of the orientation element relative to the vehicle is ensured.

According to another embodiment of the invention it is provided that the system comprises a referencing means that can be detected by the position detection unit for determining the position of the measuring unit within the travel range thereof. Within the scope of this document, the term “referencing means” should be understood to refer to means which, within the working range of the measuring unit, for example a measuring space of a motor vehicle workshop, provide an absolute coordinate system for the measuring unit which make it possible for said measuring unit to detect its position and/or orientation at any time. The use of referencing means allows for particularly precise and accurate positioning of the measuring unit relative to a motor vehicle arranged within a predetermined measuring region. Erroneous measurements and/or incorrect orientations of the advantageously provided orientation element due to positioning errors can therefore be prevented in a particularly reliable manner.

The embodiment of the referencing means may in principle be freely selected. They may for example be a wire grid inserted in a workshop floor and forming a coordinate system and that makes possible precise position detection by the position detection unit. According to another embodiment of the invention, however, the referencing means comprise markings that can be optically detected by means of the position detection unit. The markings may for example be so-called tags that can be detected using cameras, or they may be labels which, according to an advantageous further embodiment of the invention, are arranged in the floor and/or ceiling region.

The arrangement of the optically detectable marking makes possible particularly simple establishment of a measuring region within a motor vehicle workshop. For this purpose, a region provided for the surveying is provided with corresponding optically detectable markings, which make it possible for the measuring unit to detect the relevant position in space in a particularly simple manner. In particular, arrangement in the ceiling region constitutes a particularly low-maintenance and reliable option for arranging referencing means, said referencing means being protected from external influences and soiling.

After the surveying tasks to be carried out have been defined, the control unit automatically moves the measuring unit relative to the motor vehicle, the relevant vehicle-specific data being stored in the control unit for this purpose or in a database connected to the control unit. The automatic movement of the measuring unit, the control unit for this purpose prompting a corresponding movement via the travel unit, makes it possible to completely dispense with movement on the part of a user. In the process, the position detection unit ensures precise orientation of the measuring unit and, if applicable, the orientation element relative to the vehicle, the advantageously provided orientation element then automatically moving into the required position relative to the motor vehicle after the vehicle type and the vehicle sensor and/or camera to be checked and/or oriented have been defined.

A measuring unit provided with an orientation element according to a further embodiment can therefore be used universally for various vehicle types and sensors and/or cameras, it being possible for the control unit to retrieve the positioning and orientation data for the relevant tasks. The measuring unit developed in this manner also allows for simple orientation of cameras and sensors if it is necessary to arrange orientation elements at several positions for this purpose. In this way, the measuring unit can travel by means of the travel unit to the necessary positions one after the other in order to allow for precise orientation.

According to another embodiment of the invention it is provided that the control unit is connected to an obstacle detection unit. An obstacle detection unit ensures that the measuring unit does not collide with obstacles possibly arranged within the travel range during autonomous operation of said measuring unit. The obstacle detection may for example take place on the basis of lidar sensors, ultrasound sensors or cameras.

In order to orient the measuring unit relative to the motor vehicle, the position detection unit may be provided with suitable sensors, for example acceleration sensors, magnetic field sensors, inclination sensors, which allow for precise orientation of the orientation element relative to the motor vehicle. According to another embodiment of the invention it is provided that the position detection unit comprises a device for measuring the path. This is based, for example, on optical path sensors or rotary encoders and increases the accuracy of the positioning of the measuring unit in a complementary manner. The path measurement allows for precise monitoring of the distance and direction traveled.

According to another embodiment of the invention it is further provided that the measuring unit comprises a signaling unit for protecting the surroundings. This may for example involve warning lights, such as rotating lights, which signal the movement procedure to the surroundings during operation of the measuring unit, in particular during travel.

An exemplary embodiment of the invention will be explained in greater detail below with reference to the drawings, in which:

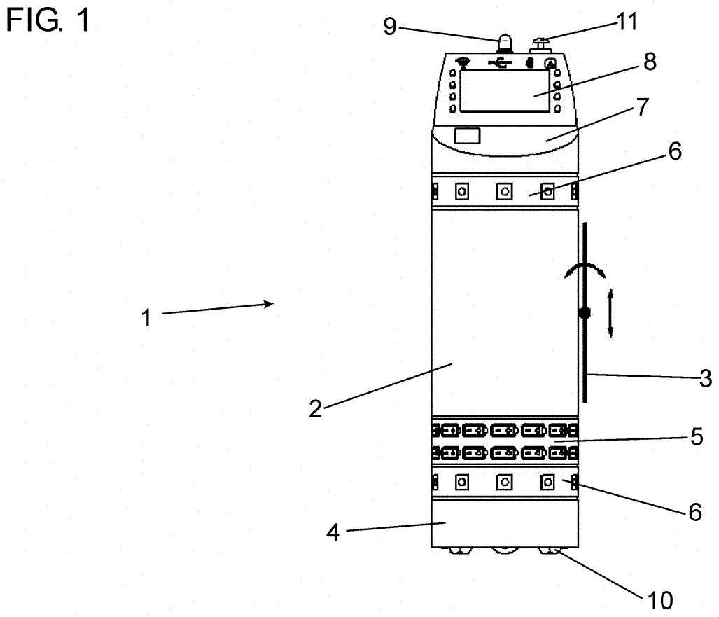

FIG. 1 is a schematic representation of an adjustment unit in a side view, and

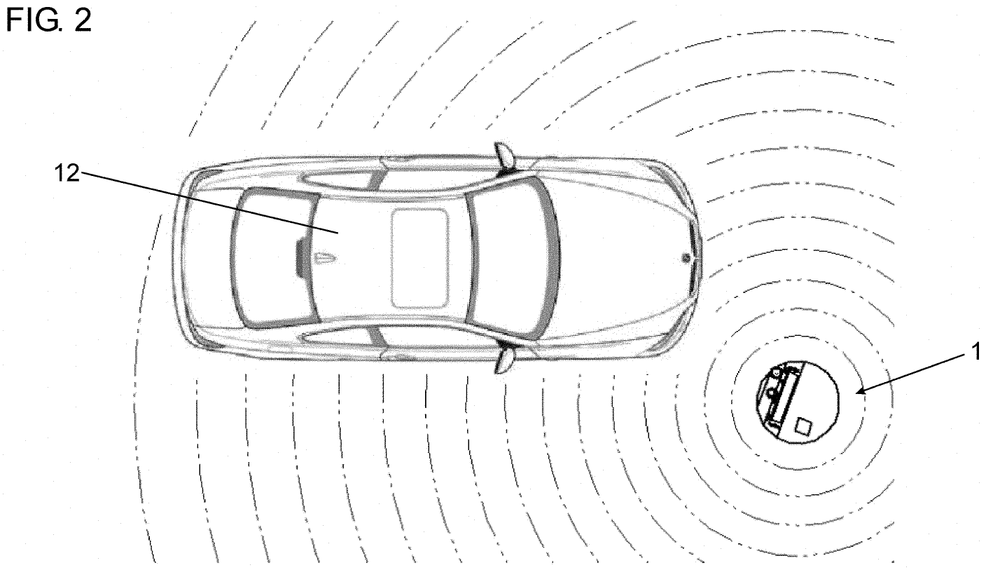

FIG. 2 is a schematic representation of the arrangement of the adjustment unit from FIG. 1 relative to a motor vehicle.

FIG. 1 shows a measuring unit 1 in a side view. Said unit comprises a base support 2, on which a laser scanner 3 is arranged so as to be adjustable in height and so as to be tiltable relative to the base support 2. The base support 2 is connected to a travel unit designed as a chassis 4 and that allows for automatic movement of the measuring unit 1 in space relative to a motor vehicle 12 (cf. FIG. 2).

A battery module 5 is provided for supplying power to the measuring unit 1 and for supplying power to all units of the measuring unit 1. Said units, in addition to the sensor modules 6 that are connected to a position detection unit (not shown), also include the central control unit (not shown), a communication unit (not shown), by means of which data required for the measuring procedure can be retrieved, for example from an external database, and also the central control unit for automatically controlling and orienting the measuring unit 1 relative to the motor vehicle 12. The measuring unit 1 can be controlled via an operating unit 7, which comprises a display 8. A signaling light 9 arranged on the operating unit 7 serves to signal operation of the measuring unit 1.

The chassis 4 comprises rollers 10 for moving the measuring unit 1. By means of the drive of said rollers, the measuring unit 1 can be both displaced and rotated. An emergency shut-off 11 makes it possible to immediately interrupt the measuring procedure in the event of a fault.

### LIST OF REFERENCE SIGNS

1 Measuring unit
2 Base support
3 Laser scanner
4 Chassis
5 Battery module
6 Sensor modules
7 Operating unit
8 Display
9 Signaling light
10 Rollers
11 Emergency shut-off
12 Motor vehicle

1. A system for automated surveying of motor vehicles, the system including a measuring unit comprising
a scanning unit for
contactless and/or tactile 3D detection of the geometry of the motor vehicle bodywork and/or
surveying of the chassis of the motor vehicle,
a travel unit for moving and orienting the measuring unit, and
a central control unit for automatically controlling the measuring unit and orienting the scanning unit relative to the motor vehicle.

2. The system according to claim 1, wherein the scanning unit is designed to optically detect the geometry of the motor vehicle bodywork and/or survey the chassis.

3. The system according to claim 1, wherein the control unit is connected to a communication unit for transmitting the motor vehicle data and/or scan data.

4. The system according to claim 1, wherein the measuring unit comprises an orientation element for orienting vehicle sensors and/or cameras on the motor vehicle.

5. The system according to claim 4, wherein the orientation element is adjustably arranged on the measuring unit.

6. The system according to claim 1, wherein the measuring unit comprises a position detection unit connected to the travel unit for determining the position of the scanning unit and/or orientation element relative to the motor vehicle and/or the vehicle sensors and/or cameras.

7. The system according to claim 1, comprising referencing means that can be detected by the position detection unit for determining the position of the measuring unit within the travel range thereof.

8. The system according to claim 7, wherein the referencing means comprise markings that can be optically detected by means of the position detection unit.

9. The system according to claim 7, wherein the referencing means are arranged in the floor and/or ceiling region.

10. The system according to claim 2, wherein the control unit is connected to a communication unit for transmitting the motor vehicle data and/or scan data.

11. The system according to claim 2, wherein the measuring unit comprises an orientation element for orienting vehicle sensors and/or cameras on the motor vehicle.

12. The system according to claim 5, wherein the measuring unit comprises a position detection unit connected to the travel unit for determining the position of the scanning unit and/or orientation element relative to the motor vehicle and/or the vehicle sensors and/or cameras.

13. The system according to claim 2, comprising referencing means that can be detected by the position detection unit for determining the position of the measuring unit within the travel range thereof.

14. The system according to claim 4, comprising referencing means that can be detected by the position detection unit for determining the position of the measuring unit within the travel range thereof.
